(19) United States
(12) Patent Application Publication
(10) Pub. No.: US 2007/0124023 A1
(43) Pub. Date: May 31, 2007

(54) Model for robot circulatory system for movement and dexterity

(76) Inventor: David Joseph Schulte, Galesburg, MI (US)

Correspondence Address: David Joseph Schulte, 4381 N. 37th Street, Galesburg, MI, 49053, US

(21) Appl. No.: 11/245,780

(22) Filed: Nov. 30, 2005

(51) Int. Cl. G06F 19/00

(52) U.S. Cl. 700/245

(57) ABSTRACT

This application is for a unique system for robotic movement and dexterity using the concept of utilizing pressurized compressed air to contract and/or retract limbs, joints, fingers or any attached device, attachment and/or extremity, such as used for gripping or releasing, movement, ambulation, dexterity or fine motor skills. The system relies upon an on-board computer/central processing device or system which would use relays or solenoids to direct pressurize air or create a closed-loop pressurization within the robot. A “lung” or storage container to house pressurized air would be located on board the robot. Tubing, valves, solenoids, switches, relays or anything to carry or distribute the pressurized air to extremities or other areas of the robot for movement, ambulation, dexterity, gripping or release, fine motor skills, power regeneration, or any other use by the robot. A small battery powered air compressor utilizing a piston in a cylinder to pressurize air or a gas, possibly within a Teflon coated or similar cylinder to reduce friction and heat or coated with other friction and/or heat reducing coating. Wires or fiber optics on board the robot will carry or relay commands and/or data from the on-board CPU computer or logic gate array and/or remotely controlled device or system such as a computer or other electronic device. Said CPU's being capable of being programmed with a set of condition or conditions, commands, decisions or self- automated and regulated, preferably with decision making capabilities.

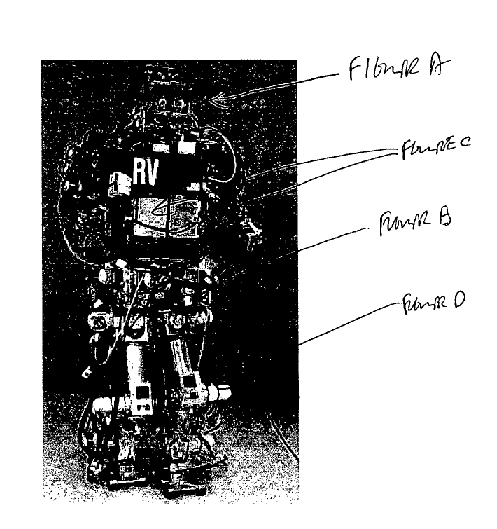

cl Paragraph 1-Theory

This application is for a unique system for robotic movement and dexterity using the concept of utilizing pressurized compressed air to contract and/or retract limbs, joints, fingers or any attached device, attachment and/or extremity, such as used for gripping or releasing, movement, ambulation, dexterity or fine motor skills. The system relies upon an on-board computer/central processing device or system which would use relays or solenoids to direct pressurize air or create a closed-loop pressurization within the robot.

A “lung” or storage container to house pressurized air would be located on board the robot. Tubing, valves, solenoids, switches, relays or anything to carry or distribute the pressurized air to extremities or other areas of the robot for movement, ambulation, dexterity, gripping or release, fine motor skills, power regeneration, or any other use by the robot. A small battery powered air compressor utilizing a piston in a cylinder to pressurize air or a gas, possibly within a Teflon coated or similar cylinder to reduce friction and heat or coated with other friction and/or heat reducing coating. Wires or fiber optics on board the robot will carry or relay commands and/or data from the on-board CPU computer or logic gate array and/or remotely controlled device or system such as a computer or other electronic device. Said CPU's being capable of being programmed with a set of condition or conditions, commands, decisions or self-automated and regulated, preferably with decision making capabilities.

Paragraph 02-Construction

This application is for a unique system for robotic movement and dexterity using the concept of utilizing pressurized compressed air to contract and/or retract limbs, joints, fingers or any attached device, attachment and/or extremity, such as used for gripping or releasing, movement, ambulation, dexterity or fine motor skills. The system relies upon an on-board computer/central processing device or system which would use relays or solenoids to direct pressurize air or create a closed-loop pressurization within the robot.

A “lung” or storage container to house pressurized air would be located on board the robot. Tubing, valves, solenoids, switches, relays or anything to carry or distribute the pressurized air to extremities or other areas of the robot for movement, ambulation, dexterity, gripping or release, fine motor skills, power regeneration, or any other use by the robot. A small battery powered air compressor utilizing a piston in a cylinder to pressurize air or a gas, possibly within a Teflon coated or similar cylinder to reduce friction and heat or coated with other friction and/or heat reducing coating.

Wires or fiber optics on board the robot will carry or relay commands and/or data from the on-board CPU computer or logic gate array and/or remotely controlled device or system such as a computer or other electronic device. Said CPU's being capable of being programmed with a set of condition or conditions, commands, decisions or self-automated and regulated, preferably with decision making capabilities.

Paragraph 03-Field of the Invention

This device and this technology relate to robotics technology.

### CROSS REFERENCE TO RELATED APPLICATIONS

I am uncertain if anything like this has been patented in the United States.

### STATEMENT REGARDING FEDERALLY SPONSORED RESEARCH AND DEVELOPMENT

Unknown at this time.

### REFERENCE TO SEQUENCE LISTING, A TABLE OR A COMPUTER PROGRAM LISTING COMPACT DISK APPENDIX

Not applicable.

### BACKGROUND OF THE INVENTION AND DESCRIPTION OF PRIOR ART

This is just an idea I had and took a chance that it is not already patented in the United States. It deals with robots.

### BRIEF SUMMARY OF THE INVENTION

This application is for a unique system for robotic movement and dexterity using the concept of utilizing pressurized compressed air to contract and/or retract limbs, joints, fingers or any attached device, attachment and/or extremity, such as used for gripping or releasing, movement, ambulation, dexterity or fine motor skills. The system relies upon an on-board computer/central processing device or system which would use relays or solenoids to direct pressurize air or create a closed-loop pressurization within the robot.

A “lung” or storage container to house pressurized air would be located on board the robot. Tubing, valves, solenoids, switches, relays or anything to carry or distribute the pressurized air to extremities or other areas of the robot for movement, ambulation, dexterity, gripping or release, fine motor skills, power regeneration, or any other use by the robot. A small battery powered air compressor utilizing a piston in a cylinder to pressurize air or a gas, possibly within a Teflon coated or similar cylinder to reduce friction and heat or coated with other friction and/or heat reducing coating. Wires or fiber optics on board the robot will carry or relay commands and/or data from the on-board CPU computer or logic gate array and/or remotely controlled device or system such as a computer or other electronic device. Said CPU's being capable of being programmed with a set of condition or conditions, commands, decisions or self-automated and regulated, preferably with decision making capabilities.

### DESCRIPTION OF PREFERRED EMBODIMENT

System would be installed into robots.

### DETAILED DESCRIPTION OF THE INVENTION

This application is for a unique system for robotic movement and dexterity using the concept of utilizing pressurized compressed air to contract and/or retract limbs, joints, fingers or any attached device, attachment and/or extremity, such as used for gripping or releasing, movement, ambulation, dexterity or fine motor skills. The system relies upon an on-board computer/central processing device or system which would use relays or solenoids to direct pressurize air or create a closed-loop pressurization within the robot.

A “lung” or storage container to house pressurized air would be located on board the robot. Tubing, valves, solenoids, switches, relays or anything to carry or distribute the pressurized air to extremities or other areas of the robot for movement, ambulation, dexterity, gripping or release, fine motor skills, power regeneration, or any other use by the robot. A small battery powered air compressor utilizing a piston in a cylinder to pressurize air or a gas, possibly within a Teflon coated or similar cylinder to reduce friction and heat or coated with other friction and/or heat reducing coating. Wires or fiber optics on board the robot will carry or relay commands and/or data from the on-board CPU computer or logic gate array and/or remotely controlled device or system such as a computer or other electronic device. Said CPU's being capable of being programmed with a set of condition or conditions, commands, decisions or self-automated and regulated, preferably with decision making capabilities.

### DRAWING/MARKED UP COPY DESCRIPTION OF FIGURES

FIG. A—Head containing Computer CPU “brain”

FIG. B—Buttock area containing batteries, one in each to keep weight evenly distributed with redundancy or backup, one battery being located within each “buttock” area.

FIG. C—“lungs” or sealed chamber's, one sealed chamber (“Lung”) located in each half of the chest cavity. Two being required for backup and keep weight evenly distributed and allow one to be used at a time or both for redundancy in which to house the compressed air or fluid which is used and controlled by the CPU to effectuate dexterity, movement and strength via controlled pressurization.

FIG. D—Depicts one of many examples of the finished robotic system wherein movement dexterity and strength would occur via installed relays, switches or solenoids each connected to the “brain” computer/CPU via fiberoptic lightweight tubing or electrical wires or wireless relays, each installed for example at each of the joints just as in a human being:
To control arms, legs, knees, elbo's, fingers, toes, ankles, neck/head movement waist movement, wrist movement, arm movement, leg movement, foot movement, eye movement, mouth/jaw, movement, etc.

1) The concept of utilizing pressurized compressed air to contract and/or retract limbs, joins, fingers or any attached device, attachment and/or extremity, such as used for gripping or releasing, movement, ambulation, dexterity or fine motor skills.

2) The concept of utilizing an on-board device or system which would pressurize air or create a pressurization within the robot.

3) The concept of using a “lung” or storage container to house pressurized air on board the robot.

4) The concept of using tubing, valves, solenoids, switches, relays or anything to carry or distribute said pressurized air to extremities or other areas of the robot for movement, ambulation, dexterity, gripping or release, fine motor skills, power regeneration, or any other use by the robot.

5) The concept of utilizing a piston in a cylinder to pressurize air or a gas, said piston and/or cylinder possibly Teflon coated or coated with other friction and/or heat reducing coating.

6) The concept of using wires or fiber optics on board the robot which will carry or relay commands and/or data from oh board and/or remotely located device or system such as a computer or other electronic device.

7) The concept of an on-board computer or CPU for the robot.

8) The concept of an on-board CPU, computer or other electronic device(s) being capable of being programmed with a set of condition or conditions, commands, decisions.
